(19) United States
(12) Patent Application Publication
(10) Pub. No.: US 2004/0045395 A1
(43) Pub. Date: Mar. 11, 2004

(54) Design of a handle for a bike

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/237,740

(22) Filed: Sep. 10, 2002

(51) Int. Cl. B62K 21/12

(52) U.S. Cl. 74/551.8

(57) ABSTRACT

A design of a handle for a bike is generally composed of a body, a cover made of transparent material, and an upper lid. The body is formed with a front cover and a rear cover, which are secured to the handle of the bike. The front cover comprises a chamber with the cover thereat to receive illumination devices and ornaments. The upper lid and a switch are located on the top portion of the body. The switch controls the illumination devices, an electric horn, or music IC. The upper lid is a push horn, which is made of soft material and can be a creature appearance. When pushing the switch, the illumination devices light up as a warning signal. While the upper lid is pushed, the horn honks to make the bike more fun and attractive.

### FIELD OF THE INVENTION

This invention relates to a design of a handle for a bike, and more particularly, to a handle which is able to honk and to illuminate, as warning and to produce attractive effect.

### BACKGROUND OF THE INVENTION

Conventional skateboards or tricycles for children on the market are mostly formed with a T-shaped handle, which structure is strong and safe to users, however, the appearances are dull and not creative, therefore can not attract consumers' in particular to children's attention.

Some inventors had designed dolls, ornaments, or stickers on the handle to increase the appearance. Some inventors even installed a horn or illumination devices to produce sound and lighting effects. But these designs are complicated in installation, and can not be combined together at same time.

In view of these and many other shortcomings, the inventor has invented the present invention.

### SUMMARY OF THE INVENTION

It is the primary object of the present invention to provide a design of a handle for a bike, which has a warning and lighting functions.

It is another object of the present invention to provide a design of a handle for a bike, which is easy to operate.

It is a further object of the present invention to provide a design of a handle for a bike, which has a creative appearance and is more attractive to consumers.

### BRIEF DESCRIPTION OF THE DRAWINGS

FIG. 1 is an exploded view of a first embodiment of the present invention;

FIG. 2 is a perspective view of the first embodiment the present invention;

FIG. 3 is an exploded view of a second embodiment of the present invention;

FIG. 4 is an exploded view of a third embodiment of the present invention;

FIG. 5 is an exploded view of a fourth embodiment of the present invention; and,

FIG. 6 is a perspective view of a fifth embodiment of the present invention.

### DETAILED DESCRIPTION OF THE PREFERRED EMBODIMENTS

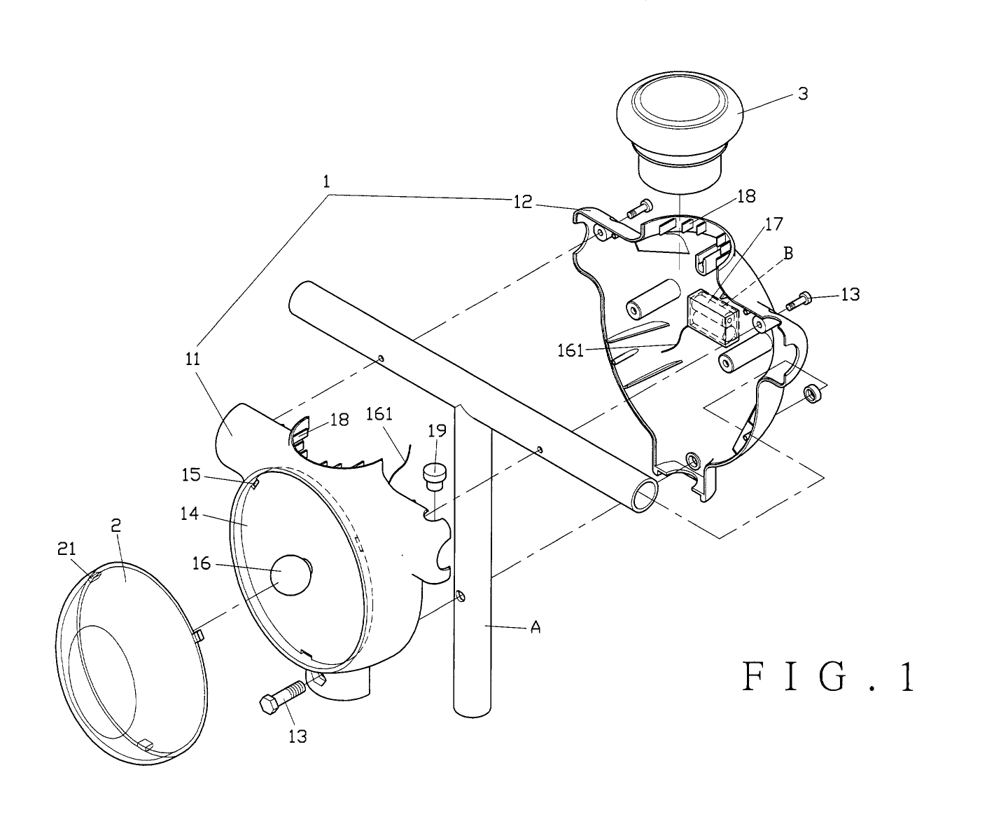

A design of a handle for a bike of the present invention, as shown in FIG. 1, comprises a body 1, a cover 2 and an upper lid 3.

The body 1 is formed with a front cover 11 and a rear cover 12, and secured to a handle A by fasteners 13. The front cover 11 has a chamber 14 at the front end, which comprises a plurality of holes 15 around the inner ridge, and an illumination device 16, which may be a light bulb, which has an extension cord 151 to connect the bulb to a battery B in a battery compartment 17 located in the inner wall of the rear cover 12. The body 1 comprises a plurality of ribs 18 at the inner top portion and a switch 19 next to the ribs 18 adapted to control the illumination device 16 turned on or off.

The cover 2 is secured onto the chamber 14 of the front cover 11, and is made of transparent material and comprises a plurality of blocks 21 on the inner ridge, which correspond to the holes 15 of the front cover 11.

The upper lid 3 is a push horn and is secured on the top of the body 1.

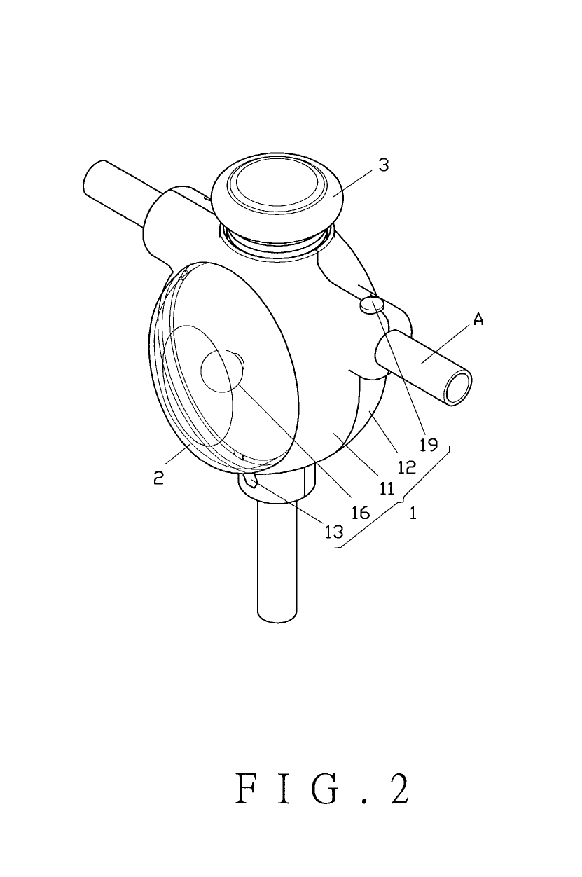

To assemble the present invention, as shown in FIG. 2, the front cover 11 and the rear cover 12 are fastened onto the handle A with the fasteners 13. The upper lid 3 is clipped by the ribs 18 and is secured to the body 1. The switch 19 is located on the top portion of the body 1 next to the upper lid 3. The cover 2 is inserted onto the front cover 11 with the blocks 21 inserting into the holes 15 of the chamber 14.

To operate the present invention, the switch 19 connects the battery B in the battery compartment 17 to the illumination device 16 through the electric wire 161 and activates the illumination device 16. This illumination device 16 not only works as an amusement but also provides as warning and headlight devices. By pushing the upper lid 3, the horn will honk to provide a warning device.

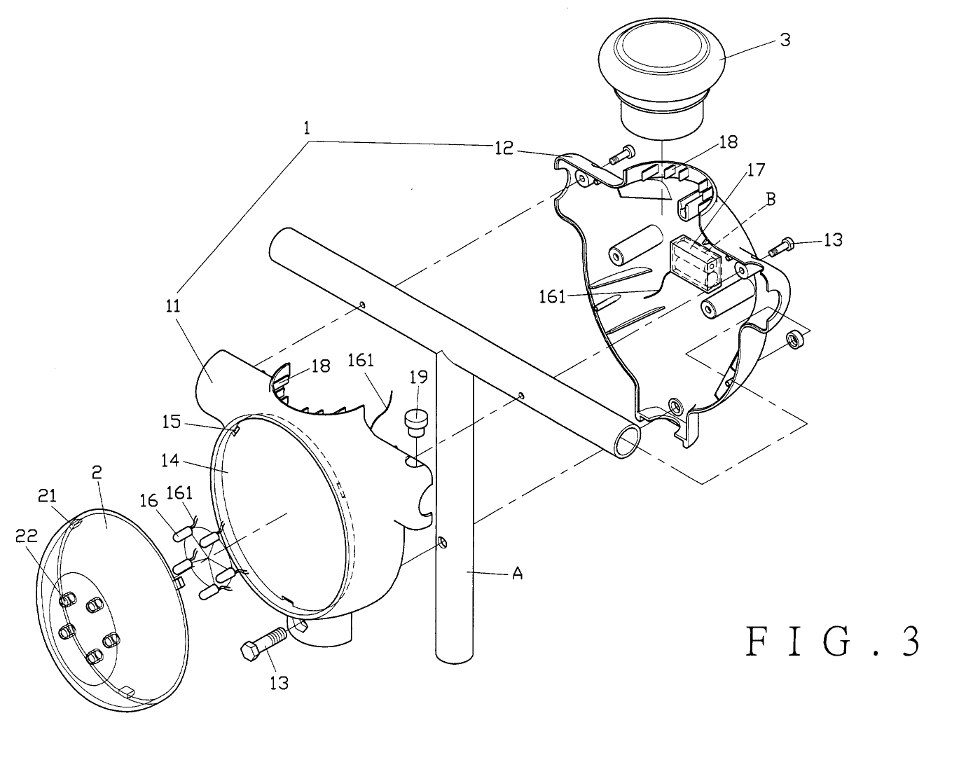

FIG. 3 shows another embodiment of the present invention, the chamber 14 comprises a plurality of illumination devices 16 which are light-emitting diodes. The inner wall of the cover 2 is formed with a plurality of recesses 22 corresponding to the illumination devices 16 both in number and in position, so that each of the illumination devices 16 is placed in a corresponding recess 22, respectively.

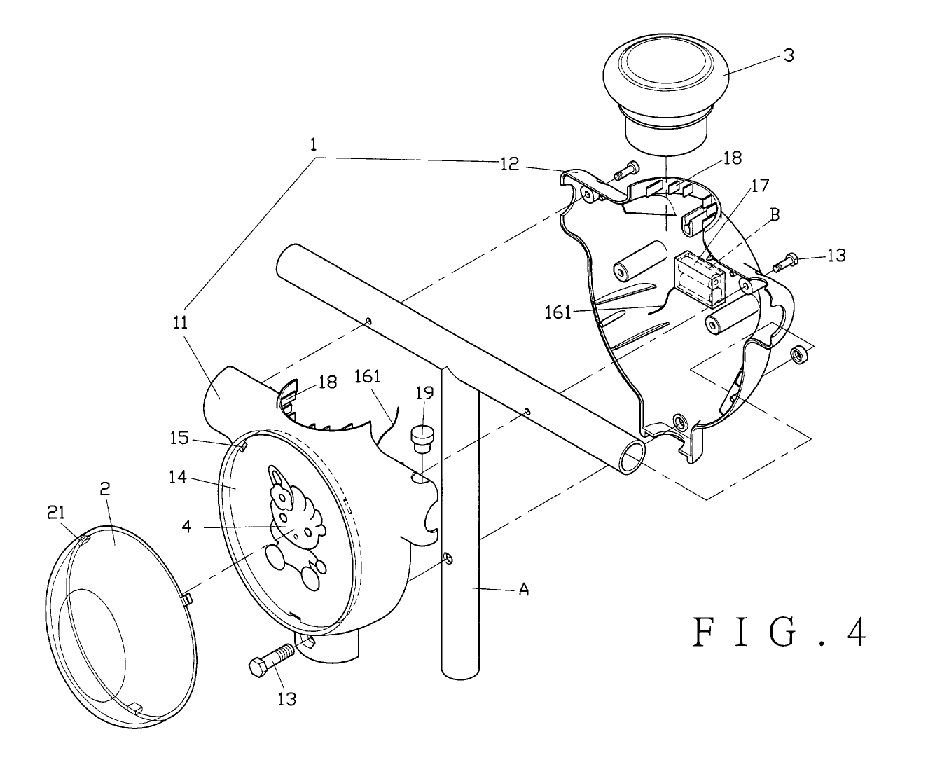

A third embodiment of the present invention is shown in FIG. 4, the chamber 14 comprises a decorative sticker 4, which draws attention to consumers. The switch 19 may be connected to an electric horn or music IC to control such devices. By pushing the switch 19, it activates the sound to broadcast pre-set music.

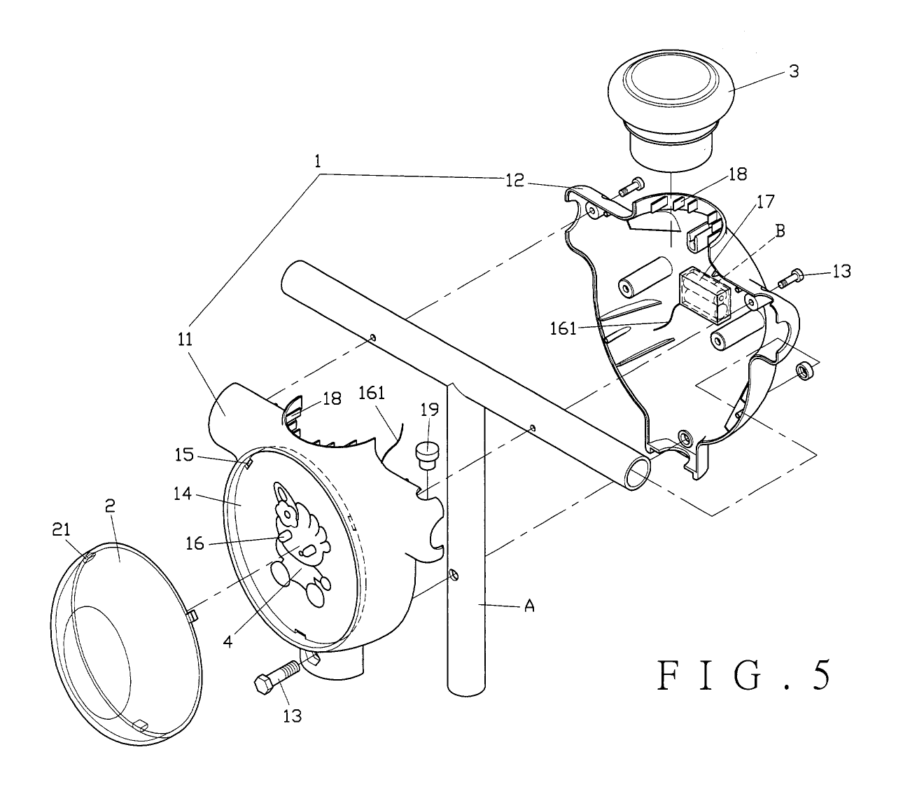

A fourth embodiment of the present invention is shown in FIG. 5, the chamber 14 comprises various stickers 4 with different pictures coupled with light-emitting diodes 16, so that the light brightens the colorful pictures to produce a more attractive image.

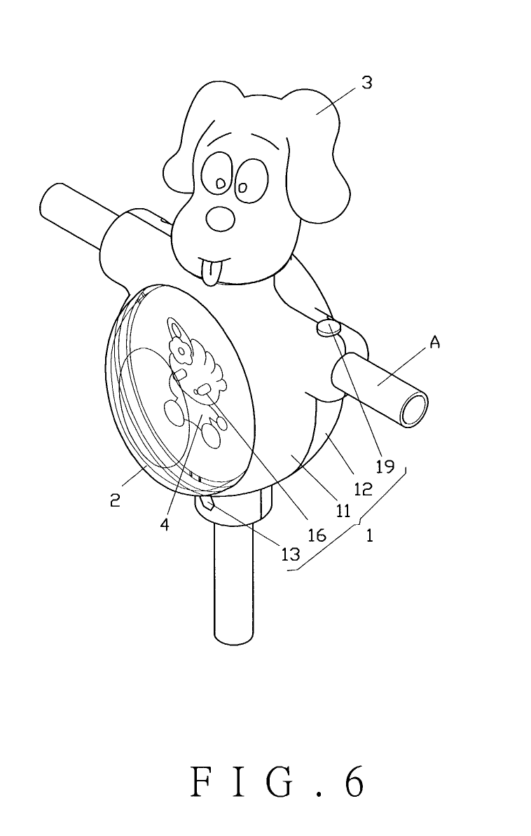

A fifth embodiment is shown in FIG. 6, the upper lid 3 uses soft material to form a creature and can be a push horn, so that when pushing the upper lid 3, the horn honks, which acts as a warning device while the creature appearance is an ornament for the decoration purpose.

I claim:

1. A design of a handle for a bike comprising a body, a cover and an upper lid secured on top of said body, wherein said body comprising a front cover and a rear cover which being combined together onto said handle, said front cover comprising a chamber, and said body comprising a plurality of ribs and a switch on top portion thereof, and being characterized in that,
said chamber comprising at least one illumination device, and being covered by said cover, said cover being made of transparent material.

2. The design of a handle for a bike, as recited in claim 1, wherein said chamber of said front cover comprises a plurality of holes around an inner edge, and said cover comprising a plurality of blocks around an inner edge and corresponding with said holes of said chamber both in number and in position.

3. The design of a handle for a bike, as recited in claim 1, wherein said illumination device is a light bulb or light-emitting diodes.

4. The design of a handle for a bike, as recited in claim 1, wherein said cover comprises at least one recess on an inner wall for said illumination device to seat therein.

5. The design of a handle for a bike, as recited in claim 1, wherein said switch is connected to said illumination device as an ON/OFF switch to said illumination device.

6. The design of a handle for a bike, as recited in claim 1, wherein said switch is connected to an electric horn or music IC.

7. The design of a handle for a bike, as recited in claim 1, wherein said chamber comprises various stickers with different pictures.

8. The design of a handle for a bike, as recited in claim 1, wherein said upper lid is a push horn and is made of soft material with a creature appearance.
